(19) United States
(12) Patent Application Publication
(10) Pub. No.: US 2007/0053198 A1
(43) Pub. Date: Mar. 8, 2007

(54) Personalized break light

(76) Inventor: Zachary Field Hooey, El Paso, TX (US)

Correspondence Address: ZACHARY FIELD HOOEY, 11725 Henry Phipps Dr., El Paso, TX, 79936, US

(21) Appl. No.: 10/973,669

(22) Filed: Oct. 23, 2004

Related U.S. Application Data
(60) Provisional application No. 60/519,577, filed on Feb. 3, 2004.

(51) Int. Cl. B60Q 1/26

(52) U.S. Cl. 362/541

(57) ABSTRACT

Break light is centered and mounted on rear edge of vehicle trunk, tailgate, or rear outer edge of vehicle hood depending on model of vehicle. Break light is mounted using common tools and adhesives.

### BACKGROUND

Personalized Break Light was founded in February of 2001 by Zachary F. Hooey, who is currently the CEO and retains 100% ownership of the enterprise. No outside capital has been used to fund the operations of the enterprise. The enterprise was founded based on the Auto industry's need to be unique and competitive. Utilizing Laser molding techniques, Mr. Hooey's, Personalized Break Light will be able to offer a unique and hip product that will attract customers of all age. This project is expected to be profitable from its infancy and expects to control the market due to exclusivity for the length of the contract to the exclusive rights of the pending patent.

Personalized Break Light expects to become recognized in the industry as a leader in the development and marketing of innovative, high quality rear vehicle spoilers. To achieve this we will:
Cater to the personal preferences of the individual consumer.
Regularly reinvest in facilities and equipment to expand production and improve quality.
Insure that at least 40% of all new development/engineering personnel hired are recent college graduates.
Introduce a new “assembled” product into our product line by 3rd quarter of next year and more in later years to maintain approximately a 50/50 Profit Before Tax (PBT) contribution from component and “assembled” products.
   I. Novel Features of Personalized Break Light

Personalized Break Light is unique to the market due to the individual personalized desire of the customer.

Personalized Break Light is different from other products on the market due to exclusivity of the product not currently offered.

Currently, there are products that covers the outside of the break light. Ex: the Dodge Ram emblem.

There are scrolling marquee's, but are illegal by DOT due to motion while moving. Our product is mounted inside the red reflective lens and is only seen when the breaks

are applied.

IV. Product Installation

Steps for Installation

1. Using panel puller remove any trim-panels from underside of decklid. It is recommended to cover or remove any carpeted trunk mats or other items in trunk area to avoid damage.

2. Place plastic T-strips into mounting holes on spoiler. A small piece of masking tape is helpful in holding T-strip in position.

3. Place spoiler on closed decklid and align to proper position. A measuring tape will ensure a “perfect” alignment.

4. Using masking tape, secure T-strips to decklid of vehicle. Remove spoiler by lifting straight up, leaving T-strips secured to decklid.

5. Using a ⅛′ drill bit, drill thru the T-strip hole and into the decklid. Remove T-strips from vehicle. If decklid contains a “double panel” Drill through inner panel also. Using a 5/16′ drill bit, drill thru the ⅛′ hole in step 4.

6. If a “double panel” exists, use a ¾′ drill bit to drill thru the “inner panel”. This allows the ratchet or nutdriver to secure the screw tightly against the upper panel.

7. Place spoiler on decklid and using supplied screws and ratchet or nutdriver secure spoiler to vehicle.

8. When installing spoilers with a L.E.D. brake light it is recommended to splice into the 3rd brake light in the vehicle and attach spoiler wires using electrical tape.

9. Apply small amounts of silicone based caulk over spoiler screws as this will help prevent leakage, rusting, or loosening of screws.

10. Reinstall any panels, mats or other items removed earlier in installation as noted in step 1.

Assembly Instructions

1. Install light by removing plastic backing on light, exposing adhesive tape. Firmly press light into groove.

2. Remove wax paper backing on neosponge gaskets, exposing the sticky adhesive.

3. Firmly press gaskets to bottom of spoiler stanchions. Make sure gaskets are centered correctly on stanchions.

Paint Instructions

1. Inspect spoiler for imperfections. If filling is required use a catalyzed body filler.

2. If a catalyzed body-filler is used, be sure to prime over spot.

3. Sand spoiler with a 400 grit (or finer) wet sand paper until surface is smooth.

4. Apply basecoat/clearcoat finish of your choice.

Note:

This spoiler has been coated with a catalyzed primer/sealer. Unless additional filling has been done, no primer is required.

Caution:

Do not fill, cover or obstruct vent holes in the bottom of the spoiler. These holes are essential for proper ventilation of fiberglass fumes.

Important:

Please inspect your spoiler for proper fit before painting or mounting. Parts which have been sanded, painted, drilled or modified cannot be returned.

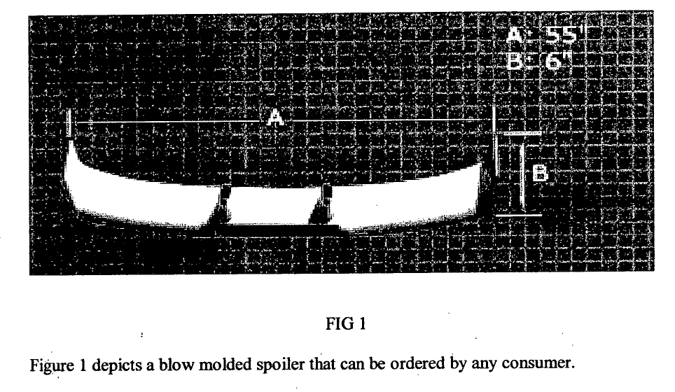

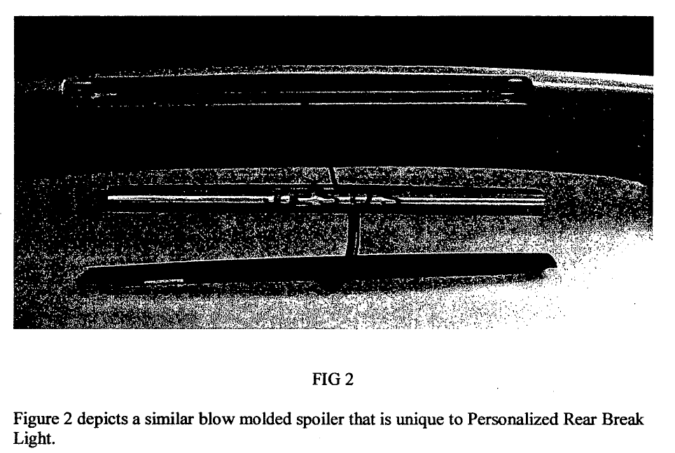

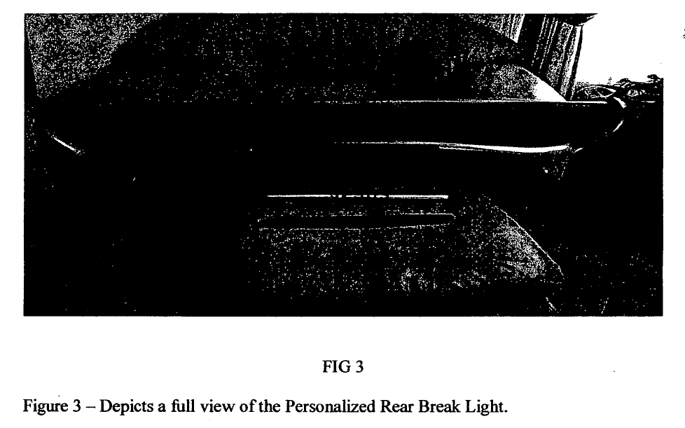

1. Rear Break Light (see specifications below)
a AU rear break lights on cars and trucks are not the same size and varies as to the placement by the automobile manufacture (FIG. 1).
b. Personalized Break Light will provide a standard size window that is centered in the rear spoiler of a vehicle (FIG. 3).
c. Personalized break Light uses Galvanized Steel, 0.25′ thick, to make its product. The steel is cut on a Laser Cutter and will not rust. The thickness will not allow the metal to melt to the reflective lens causing the product to last the length of the life of the automobile (FIG. 2).
d. The galvanized steel can be replaced if desired by reordering if car is sold or damaged.
e. The galvanized steel will be 3″ in height and 42′ in length to fit the rear spoiler of the smallest cars.

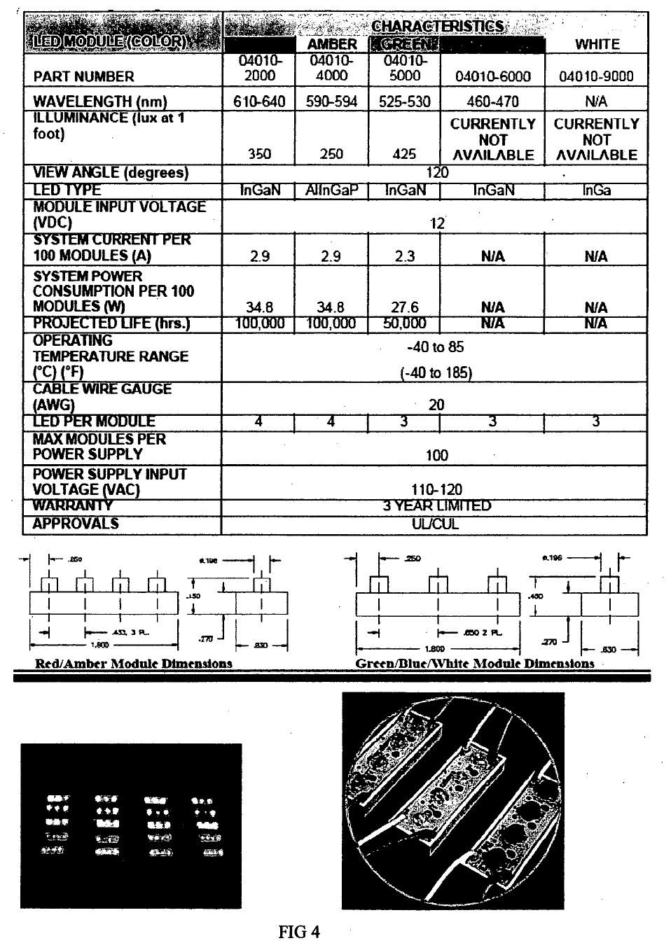

2. LED Lights (Red)
a Standard 100,000 hour LED lights will be used for longevity and visibility (FIG. 4). 100,000 hour led lights last for 20 years. LED lights will be sealed with a rubber gasket to protect from weather damage and to allow for interchangeability.
b. LED lights will be installed along with the personalized galvanized steel plate by the manufacturer and sealed with the red reflector. The only installation required by the consumer will be mounting the rear wing spoiler onto the rear of the vehicle.

3. Red Reflector Lens
a. Red reflector lens will be one size (3″×42″) and will cover galvanized steel as stated above.

4. Galvanized Steel
a Galvanized steel will be 0.25′ thick. Galvanized steel will not rust or melt onto red reflective lens.
